(19) United States
(12) Patent Application Publication
(10) Pub. No.: US 2020/0125127 A1
(43) Pub. Date: Apr. 23, 2020

(54) APPARATUS FOR BYPASSING A LOAD CURRENT GOING THROUGH AN AC-AC SERIES VOLTAGE REGULATOR UNDER OVERCURRENT CONDITION

(71) Applicant: Edge Electrons Limited, Hong Kong (HK)

(72) Inventors: Jian Carlo Decena ZAPATA, Pampanga (PH); Gordon CURRIE, Makati City (PH); Neal George STEWART, Makati City (PH)

(21) Appl. No.: 16/618,406

(22) PCT Filed: Jun. 1, 2018
(86) PCT No.: PCT/IB2018/053931

§ 371 Date: Dec. 2, 2019

Related U.S. Application Data
(60) Provisional application No. 62/514,149, filed on Jun. 2, 2017.

(51) Int. Cl. G05F 1/575; H02M 1/32; H02M 5/22

(52) U.S. Cl. CPC G05F 1/575; H02M 5/22; H02M 1/32

(57) ABSTRACT

An apparatus is provided for bypassing a load current going through an AC-AC series voltage regulator under over-current condition, comprising: an AC-AC invertor; an AC semiconductor bypass switch; and a bypass control. The AC-AC invertor and the AC semiconductor bypass switch are connected in parallel. The bypass control is configured to detect a load current signal, an input voltage of the AC-AC series voltage regulator and an output voltage of the AC-AC series voltage regulator and to control the AC semiconductor bypass switch's switching such that the load current under overcurrent condition is shared between the AC-AC invertor and the AC semiconductor bypass switch.

### CROSS-REFERENCE OF RELATED PATENTS AND PATENT APPLICATIONS

This application claims priority under the Paris Convention to the U.S. Provisional Patent Application No. 62/514,149, filed Jun. 2, 2017, the disclosure of which is incorporated herein by reference in their entirety.

### FIELD OF THE INVENTION

The present invention generally relates to electronic AC-AC series voltage regulation topologies that utilize invertor power semiconductors to handle the total peak power to the load. Particularly, the present invention relates to methods and systems for bypassing load alternating current going through an AC-AC series voltage regulator under overcurrent condition.

### BACKGROUND

Alternating current (AC) voltage regulators are used to closely control and regulate the AC voltage level being delivered to a load connected to the output of the AC voltage regulator, regardless of the AC voltage variation at the input of the AC voltage regulator. The electronic AC-AC series voltage regulation topology, can be either any “direct” topology in which that invertor power semiconductors are to handle the total peak power to the load, or any “indirect” electronic AC-AC series voltage regulator topology that utilizes a low frequency transformer (the low frequency transformer may be one of those disclosed in PCT Application No. PCT/IB2017/055260; the disclosure of which is incorporated by reference herein in its entirety) that only processes a proportion of the total output power. However, the inherent limited power handling capability of invertor power semiconductor devices may cause problems in the electronic AC-AC series voltage regulation. It is well-known in the art that a small semiconductor die could only handle current transients of limited peak amplitudes from switched reactive loads owning to the limited critical thermal dissipation of the small power semiconductor die. Conventionally, invertor power semiconductor devices are protected from overcurrent by a bypass, which directly connects the unregulated input voltage to the output and essentially removes the AC voltage regulation function. However, in some applications where the AC input voltages are normally high, i.e. in a mains grid connection, the removal of the AC voltage regulation function may cause annoying lighting flickers or even destructive voltage fluctuations, which could damage and/or shorten the lifetime of electrical equipment.

FIG. 1 shows a general electronic AC-AC series voltage regulator with a standard legacy simple bypass comprising typically a semiconductor bypass switch, an electromechanical relay or contactor bypass for protecting the invertor power semiconductor devices undergoing high peak currents in accordance with a prior art example. A current amplitude detector is used for detecting transient peak current amplitudes from the load current sensor, and bypass drivers are used for triggering the simple bypass. The semiconductor bypass switch may be fast switching AC semiconductor devices such as TRIACS, or SCRs, either back-to-back, or with a rectifier bridge connected in parallel with the contacts of the slower electromechanical relay or contactor. As such, the simple bypass may function as fast protective bypass with fast AC power semiconductors together with the slower electromechanical relay or contactor.

The AC loads may include resistive loads and reactive loads. When reactive loads are switched to the invertor, momentary high peaks of the load current, which last only for microseconds or milliseconds, may induce a very high transient invertor current peak which exceeds a pre-set protective current level such that the simple bypass is unnecessarily triggered. Consequently, the input of the AC voltage regulator is connected directly to the output hence the high unregulated input voltage is delivered to the load, which may lead to annoying lighting flickers or even destructive voltage fluctuations. Summary:

It is one objective of the present invention to provide a smart bypass so as to directly alleviate or eliminate the critical industry inherent problem of the negative impacts associated with the standard legacy simple bypass. According to one aspect of the present invention, an apparatus is provided for bypassing a load current going through an AC-AC series voltage regulator under overcurrent condition, comprising: an AC-AC invertor; an AC semiconductor bypass switch; and a bypass control. The AC-AC invertor and the AC semiconductor bypass switch are connected in parallel. The bypass control is configured to detect a load current signal, an input voltage of the AC-AC series voltage regulator and an output voltage of the AC-AC series voltage regulator and to control the AC semiconductor bypass switch's switching such that the load current under overcurrent condition is shared between the AC-AC invertor and the AC semiconductor bypass switch.

FIG. 2 shows the wave forms of the load current, the input voltage of the AC-AC series voltage regulator and the output voltage of the AC-AC series voltage regulator when an apparatus according to one embodiment of the present invention is operated under normal load condition and overcurrent condition respectively. Under normal load condition, the apparatus is operated in an Invertor Mode (Region A), wherein only the AC-AC invertor is used to handle the load current. Under overcurrent condition, the apparatus is firstly operated in a Current Controlled Smart Invertor Mode (Regions B), wherein the AC-AC invertor only partially processes a part of the load current; and then in a Smart Bypass Mode (Regions C), wherein the AC Semiconductor Bypass Switch is activated to process the remaining balance of the load current, as indicated in the shaded areas. By consecutively switching the operation between the Current Controlled Smart Invertor Mode and the Smart Bypass Mode, the total load current is effectively shared between the AC-AC invertor and the AC semiconductor bypass switch to maintain a regulated voltage output to the load without the need of the electromechanical bypass relay or contractor and to maintain the average power being processed by the invertor.

### BRIEF DESCRIPTION OF THE DRAWINGS:

Embodiments of the invention are described in more detail hereinafter with reference to the drawings, in which

FIG. 1 depicts a general electronic AC-AC series voltage regulator with a standard simple bypass according to a prior art example;

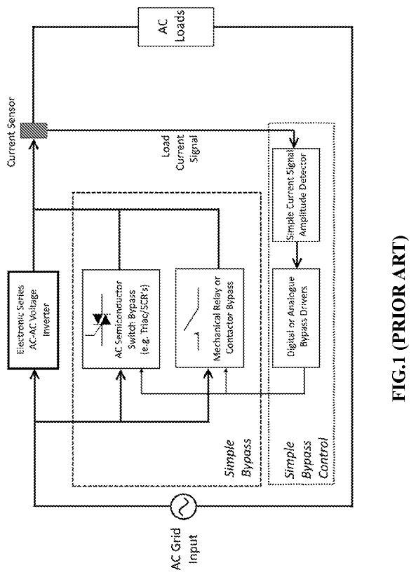

FIG. 2 shows the wave forms of the load current, the input voltage, and the output voltage of the AC-AC series voltage regulator when an apparatus, according to one embodiment of the present invention, is operated under normal load condition and overcurrent condition respectively; and

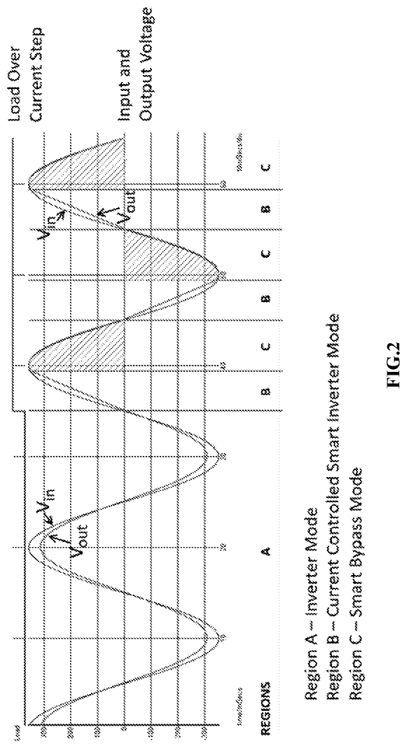

FIG. 3 depicts an apparatus for bypassing a load current passing through an AC-AC series voltage regulator under overcurrent condition in accordance with one embodiment of the present invention.

### DETAILED DESCRIPTION:

In the following description, methods, systems, and apparatuses for bypassing a load current going through an AC-AC series voltage regulator under overcurrent condition and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

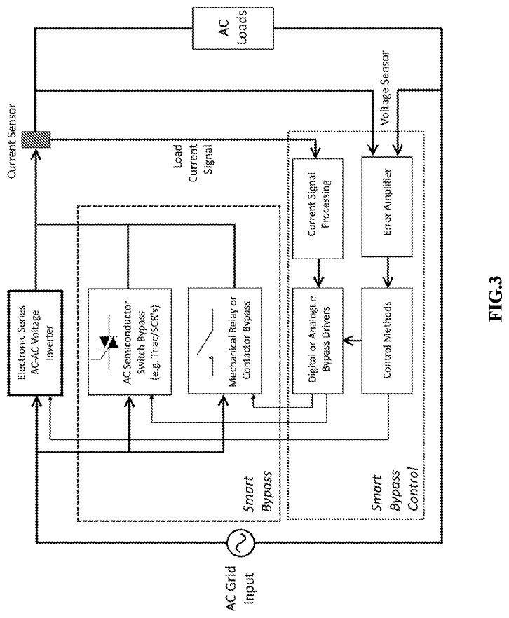

FIG. 3 shows an apparatus for bypassing a load current passing through an AC-AC series voltage regulator under overcurrent condition in accordance with one embodiment of the present invention. The apparatus comprises an AC-AC invertor, an AC semiconductor bypass switch connected in parallel with the invertor; and a bypass control. The bypass control is configured to detect a load current signal, an input voltage of the AC-AC series voltage regulator, and an output voltage of the AC-AC series voltage regulator. The bypass control is further configured to control the AC semiconductor bypass switch's switching such that the load current under overcurrent condition is shared between the AC-AC invertor and the AC semiconductor bypass switch.

The AC semiconductor bypass switch may be one of fast switching AC semiconductor devices such as Triacs, thyristor, IGBT, BJT, FET, back-to-back SCR, and rectifier bridge connected in parallel with the contacts of a slower electromechanical relay or contactor.

The bypass control may be configured to close the AC semiconductor bypass switch during trailing edges or leading edges of the half wave cycles of the load current under overcurrent condition. In various embodiments, an AC semiconductor thyristor may be used to handle large current surges at the trailing edge as they need not be commutated. Alternatively, AC active switches, such as IGBT, BJT, FET, may be used to bypass the transient overcurrent during the leading edge of the half wave cycles of the load current under overcurrent condition.

The bypass control may comprise a current signal processor for comparing the amplitude of the load current with one or more reference current values; an error amplifier, such as a proportionalintegralderivative (PID) error amplifier, for comparing the amplitude of the output voltage of the AC-AC series voltage regulator with one or more reference voltage values; and a bypass driver connected with the current signal processor and the error amplifier. The bypass driver is configured to drive the AC semiconductor bypass switch to bypass the load current when any one or more of the amplitude of the load current and the amplitude of the output voltage of the AC-AC series voltage regulator are higher than their respective reference values.

In various embodiments, the reference current values and reference voltage values are stored in one or more digital look up tables. A control loop may be implemented using the look up tables to drive and activate the AC semiconductor bypass switch at a specific phase of the half wave cycle. The control loop may be implemented with analog or digital circuitries, such as a microprocessor embedded in the bypass control, to precisely control the timing and phase of the triggering of the semiconductor bypass switch during the wave cycles.

In various embodiments, the apparatus may further comprise one or more current sensors, such as a current transformer (CT), for measuring the current waveform. The current sensor may be configured at the load itself to generate a load current waveform or inside the invertor to ensure that the current flowing through the invertor will not exceed any ratings.

In some cases, the load may include reactive elements where the load current is not in phase with the output voltage of the AC series voltage regulator. A current sensor may be used to detect whether the load current value is zero to determine the commutation of the AC semiconductor bypass switch. The invertor may continue to supply power to the load starting from 100% duty cycle and then shape the invertor output voltage in one of the forms including, but not limited to, a slope, a curve, and other possible shapes to minimize harmonics at the load. Also, the control loop may be a closed-loop where the reference signal is shaped depending on the application and the number of invertors used for current sharing.

When the overcurrent condition subsides, the bypass control may be configured to open the AC semiconductor bypass and increase the duty cycle of the alternating current passing through the invertor in the form of a slope, a curve, or any other rising shape up to 100% such that the current transition between the AC semiconductor bypass switch and the invertor does not create any abrupt voltage change and generate harmonics at the load.

In some embodiments, the apparatus may further comprise a semiconductor relay device and an electromechanical bypass device, both connected across in parallel with the AC semiconductor switch bypass and the AC-AC invertor. The semiconductor relay device and the electromechanical bypass device are triggered and controlled by the bypass control to divert the transient load current away from the AC-AC invertor and/or the AC semiconductor bypass switch under very high overcurrent conditions where the AC semiconductor bypass switch is not capable to handle the overcurrent.

Although the foregoing description and the drawings describe only a single-phase AC system, any ordinarily skilled person in the art can apply the inventive principles described herein to any poly-phase AC systems, such as three-phase electrical systems, without departing from the scope and spirit of the invention.

The embodiments disclosed herein may be implemented using general purpose or specialized computing devices, computer processors, microcontrollers, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. An apparatus for bypassing a load current going through an AC-AC series voltage regulator under overcurrent condition, comprising:
an AC-AC invertor;
an AC semiconductor bypass switch; and
a bypass control;
wherein the AC-AC invertor and the AC semiconductor bypass switch are connected in parallel;
wherein the bypass control is configured to detect a load current signal, an input voltage of the AC-AC series voltage regulator, and an output voltage of the AC-AC series voltage regulator; and
wherein the bypass control is further configured to control the AC semiconductor bypass switch's switching such that the load current under overcurrent condition is shared between the AC-AC invertor and the AC semiconductor bypass switch to regulate the output voltage of the AC-AC series voltage regulator and maintain average power being processed by the AC-AC invertor.

2. The apparatus of claim 1, wherein the bypass control comprises:
a current signal processor for comparing the amplitude of the load current with one or more reference current values;
an error amplifier for comparing the amplitude of the output voltage of the AC-AC series voltage regulator with one or more reference voltage values; and
a bypass driver connected with the current signal processor and the error amplifier;
wherein the bypass driver drives the AC semiconductor bypass switch to bypass the load current such that the load current is shared between the AC-AC invertor and the AC semiconductor bypass switch when any one of the amplitudes of the load current and the output voltage of the AC-AC series voltage regulator is higher than their respective reference values.

3. The apparatus of claim 1, wherein the AC semiconductor bypass switch comprises one or more of Triacs, thyristor, IGBT, BJT, FET, back-to-back SCR, and rectifier bridge.

4. The apparatus of claim 1, further comprising an electromechanical bypass or contactor bypass connected in parallel with the AC-AC invertor and the AC semiconductor bypass switch;
wherein the bypass control is further configured to control the electromechanical bypass or contactor bypass's switching.

5. The apparatus of claim 1, wherein the bypass control is further configured to close the AC semiconductor bypass switch during trailing edges of half wave cycles of the load current under overcurrent condition.

6. The apparatus of claim 1, wherein the bypass control is further configured to close the AC semiconductor bypass switch during leading edges of half wave cycles of the load current under overcurrent condition.

7. The apparatus of claim 1, further comprising a current transformer (CT) for sensing the load current waveform.
